(19) United States
(12) Patent Application Publication
(10) Pub. No.: US 2022/0100715 A1
(43) Pub. Date: Mar. 31, 2022

(54) DATABASE MIGRATION

(71) Applicant: SAP SE, Walldorf (DE)

(72) Inventors: Juchang Lee, Seoul (KR); Ivan Veselinov Andreev, Sofia (BG); Eunsang Kim, Seoul (KR); Jaehwa Kim, Seoul (KR); Yong Sik Kwon, Seoul (KR); Joo Yeon Lee, Seoul (KR); Jian Luo, Shanghai (CN); Myunggon Park, Seoul (KR); Edward-Robert Tyercha, Heidelberg (DE); Zheng-Wei Wang, Shanghai (CN); Paul Willems, Heidelberg (DE)

(21) Appl. No.: 17/210,393

(22) Filed: Mar. 23, 2021

Related U.S. Application Data
(60) Provisional application No. 63/083,391, filed on Sep. 25, 2020.

(51) Int. Cl. G06F 16/21; G06F 16/25; G06F 21/62; G06F 21/60

(52) U.S. Cl. CPC G06F 16/214; G06F 16/258; G06F 2221/2141; G06F 21/602; G06F 21/6218

(57) ABSTRACT

A physio-logical migration of a database from a source system to a target system may include exporting a catalog of the database in a data interchange format that preserves the hierarchical dependencies present amongst the entities included in the catalog. The physio-logical migration of the database may further include exporting the contents of a table in the database in a binary format compatible at the target system. The binary format may be a data buffer having a metadata portion, a fixed-size portion, and a page chain portion. Where the target system is a cloud-based system, the physio-logical migration of the database may include exporting the catalog and the contents of the table to a cloud-based object store before importing the catalog and the contents of the table to the target system. Related systems and articles of manufacture, including computer program products, are also provided.

### CROSS REFERENCE TO RELATED APPLICATION

This application claims priority to U.S. Provisional Application No. 63/089,391, filed on Sep. 25, 2020, entitled “DATABASE MIGRATION,” the disclosure of which is incorporated herein by reference in its entirety.

### TECHNICAL FIELD

The subject matter described herein relates generally to database processing and more specifically to techniques for migrating a database.

### BACKGROUND

A database (e.g., a relational database, a non-relational database, and/or the like) may be configured to store a plurality of electronic data records. These data records may be organized into various database objects including, for example, database tables, graphs, and/or the like. The database may be coupled with a database management system (DBMS) that supports a variety of operations for accessing the data records held in the database. These operations may include, for example, structure query language (SQL) statements, a graph query language statement, and/or the like.

### SUMMARY

Systems, methods, and articles of manufacture, including computer program items, are provided for migrating a database. In one aspect, there is provided a system. The system may include at least one data processor and at least one memory. The at least one memory may store instructions that cause operations when executed by the at least one data processor. The operations may include: receiving, from a client device, an indication to migrate a database from a source system to a target system; and in response to the indication, performing a physio-logical migration of the database by at least exporting, from the source system, one or more catalogs of the database in a data interchange format, the one or more catalogs including a plurality of entities, and the data interchange format preserving a hierarchical dependency amongst the plurality of entities, and exporting, from the source system, a content of one or more tables of the database in a binary format.

In some variations, one or more features disclosed herein including the following features can optionally be included in any feasible combination. A portion of the one or more catalogs and/or the one or more tables from being migrated to the target system may be excluded based at least on the indication from the client device.

In some variations, the binary format may be a data buffer including a metadata portion, a fixed size portion, and a page chain portion. The metadata portion may include information that enables the target system to parse the data buffer. The fixed size portion may include one or more fixed-size values. The page chain portion may include one or more variable-size values.

In some variations, the content of the one or more tables of the database may be exported in one or more sequences of data buffers. Each of the one or more sequences of data buffers may store data from one row of a table in the database.

In some variations, each of the one or more sequences of data buffers may include a plurality of chunks. Each of the plurality of chunks may be associated with an identifier to enable a detection of one or more missing chunks. A first chunk in the plurality of chunks may include metadata identifying a name, an internal identifier, and/or an order of one or more columns included in a corresponding row.

In some variations, the data interchange format may be a JavaScript Object Notation (JSON) format.

In some variations, the exporting of the one or more catalogs of the database may include exporting a first user and/or a first privilege defined at the source system. The exporting of the one or more catalogs of the database may exclude a second user and/or a second privilege not supported at the target system.

In some variations, the exporting of the one or more catalogs of the database may include exporting one or more credentials.

In some variations, the exporting of the one or more credentials may include decrypting, based at least on a root key, the one or more credentials prior to exporting the one or more credentials.

In some variations, the exporting of the one or more credentials may include exporting the one or more credentials encrypted using a root key and the root key for decrypting the one or more credentials.

In some variations, the physio-logical migration of the database further may include importing, to the target system, the one or more catalogs of the database in the data interchange format and the content of the one or more tables of the database in the binary format.

In some variations, the one or more catalogs and/or the content of the one or more tables may be exported from the source system to a cloud-based object store before being imported to the target system from the cloud-based object store.

In some variations, the source system may be a legacy system and the target system may be a cloud-based system.

In some variations, the source system and the target system may be in-memory, column-oriented, relational database systems.

In another aspect, there is provided a method for migrating a database. The method may include: receiving, from a client device, an indication to migrate a database from a source system to a target system; and in response to the indication, performing a physio-logical migration of the database by at least exporting, from the source system, one or more catalogs of the database in a data interchange format, the one or more catalogs including a plurality of entities, and the data interchange format preserving a hierarchical dependency amongst the plurality of entities, and exporting, from the source system, a content of one or more tables of the database in a binary format.

In some variations, one or more features disclosed herein including the following features can optionally be included in any feasible combination. The method may further include excluding, based at least on the indication from the client device, a portion of the one or more catalogs and/or the one or more tables from being migrated to the target system.

In some variations, the binary format may be a data buffer including a metadata portion, a fixed size portion, and a page chain portion. The metadata portion may include information that enables the target system to parse the data buffer. The fixed size portion may include one or more fixed-size values. The page chain portion may include one or more variable-size values.

In some variations, the data interchange format may be a JavaScript Object Notation (JSON) format.

In some variations, the physio-logical migration of the database may further include importing, to the target system, the one or more catalogs of the database in the data interchange format and the content of the one or more tables of the database in the binary format. The one or more catalogs and/or the content of the one or more tables may be exported from the source system to a cloud-based object store before being imported to the target system from the cloud-based object store.

In another aspect, there is provided a computer program product including a non-transitory computer readable medium storing instructions. When executed by at least one data processor, the instructions may cause operations that include: receiving, from a client device, an indication to migrate a database from a source system to a target system; and in response to the indication, performing a physio-logical migration of the database by at least exporting, from the source system, one or more catalogs of the database in a data interchange format, the one or more catalogs including a plurality of entities, and the data interchange format preserving a hierarchical dependency amongst the plurality of entities, and exporting, from the source system, a content of one or more tables of the database in a binary format.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to database migration, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts a system diagram illustrating an example of a database migration system, in accordance with some example embodiments;

FIG. 2A depicts a schematic diagram illustrating an example of a physio-logical migration of a database, in accordance with some example embodiments;

FIG. 2B depicts a schematic diagram illustrating an example of a process for a physio-logical migration of a database from a source system to a target system, in accordance with some example embodiments;

FIG. 3A depicts a block diagram illustrating an example of an architecture of a catalog migrator implemented as a standalone tool, in accordance with some example embodiments;

FIG. 3B depicts an example of a catalog and a corresponding JavaScript Object Notation (JSON) representation of the catalog, in accordance with some example embodiments;

FIG. 4 depicts a flowchart illustrating an example of a process for migrating a database, in accordance with some example embodiments; and

FIG. 5 depicts a block diagram illustrating an example of a computing system, in accordance with some example embodiments.

When practical, similar reference numbers denote similar structures, features, or elements.

### DETAILED DESCRIPTION

A database may be migrated from a source system to a target system. For example, the database migration may be necessitated by the source system being outdated, incurring more overhead, and/or lacking the features of the target system. One conventional technique for migrating the database from the source system to the target system may be a physical database migration in which the target system is restored based on a physical backup image of the source system. However, a physical database migration may require the source system and the target system to be binary-compatible. Another conventional technique for migrating the database from the source system to the target system may be a logical database migration in which the database is exported from the source system to the target system in a neutral format such as a comma-separated value (CSV) format and/or the like. Exporting the database in the comma-separated value (CSV) format may eliminate hierarchical dependencies present in the data while adding bulk to the data. As such, neither a physical database migration nor a logical database migration may be efficient for migrating a database between a source system and a target system having a same root source code but whose database formats (e.g., persistence file representations and/or the like) are not binary-compatible.

In some example embodiments, a physio-logical migration may be performed in order to migrate a database between a source system and a target system having a same root source code but non-binary-compatible persistence file representations. For example, the physio-logical migration may be performed to migrate a database from a legacy system and to a cloud-based system. The physio-logical migration may include exporting one or more catalogs of the database to a data interchange format, such as a JavaScript Object Notation (JSON) representation, that preserves the hierarchical dependencies present amongst the entities included in the catalogs. Contrastingly, exporting the catalogs in a common-separated value (CSV) format, as in the case of a conventional logical database migration, may eliminate the hierarchical dependencies present within the entities included the catalogs. Furthermore, the physio-logical migration may include exporting the contents the tables in the database to a binary representation (e.g., a data buffer) compatible with the target system. This binary representation may be more compact than the flat representation of the comma-separated value (CSV) format such that the migration of the database may be accomplished with more efficiency (e.g., requiring less time, consuming less network bandwidth, and/or the like). Moreover, the physio-logical migration of the database may be performed selectively such that one or more portions of the database (e.g., tables, columns, usernames, and/or the like) at the source system may be excluded from being migrated to the target system.

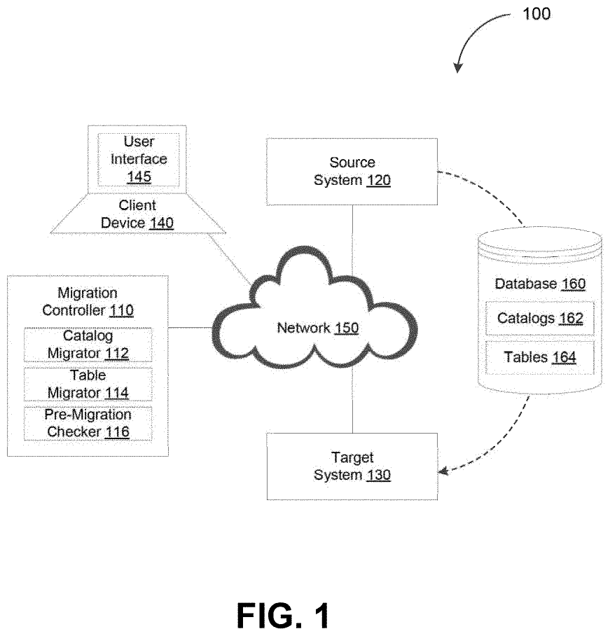

FIG. 1 depicts a system diagram illustrating a database migration system 100, in accordance with some example embodiments. Referring to FIG. 1, the database migration system 100 may include a migration controller 110, a source system 120, a target system 130, and a client device 140. The migration controller 110, the source system 120, the target system 130, and the client device 140 may be communicatively coupled via a network 150. The client device 140 may be a processor-based device including, for example, a cellular phone, a smartphone, a tablet computer, a laptop computer, a desktop, a workstation, and/or the like. The network 150 may be a wired network and/or a wireless network including, for example, a public land mobile network (PLMN), a local area network (LAN), a wide area network (WAN), a virtual local area network (VLAN), the Internet, and/or the like.

In some example embodiments, the migration controller 110 may perform a physio-logical migration in order to migrate a database 160 from the source system 120 to the target system 130. The source system 120 and the target system 130 may be co-located on a same hardware machine, in which case the physio-logical migration of the database 160 may be accomplished by exporting the data associated with the database 160 (e.g., catalogs, table contents, and/or the like) from the source system 120 to a local disk where the data may be read directly by the target system 130. Alternatively, the source system 120 and the target system 130 may be remotely located, in which case the physio-logical migration of the database 160 may be accomplished by transferring the data associated with the database 160 via the network 150, for example, over a network connection established between the source system 120 and the target system 130. Where the target system 130 is a cloud-based system located in a cloud space, the physio-logical migration of the database 160 maybe performed by exporting the data associated with the database 160 to a cloud-based storage service and/or a cloud-based object store. For example, the source system 120 may be a legacy in-memory, column-oriented, relational database system while the target system 130 may be a cloud-based in-memory, column-oriented, relational database system.

Referring again to FIG. 1, the database 160 may include one or more catalogs 162 and one or more tables 164. The migration controller 110 may include a catalog migrator 112 configured to migrate the one or more catalogs 162 and a table migrator 114 configured to migrate the contents of the one or more tables 164. In some example embodiments, the migration controller 110 may perform a physio-logical migration in which the catalog migrator 112 migrates the catalogs 162 by exporting the catalogs 162 to a data interchange format (e.g., a JavaScript Object Notation (JSON) representation and/or the like) and the table migrator 114 migrates the contents of the tables 164 by exporting the contents of the table 164 to a binary representation (e.g., a data buffer) compatible for the target system 130. Moreover, as shown in FIG. 1, the migration controller 110 may also include a pre-migration checker 116 configured to verify the status of the source system 120 and/or the target system 130 prior to initiating the physio-logical migration of the database 160 from the source system 120 to the target system 130.

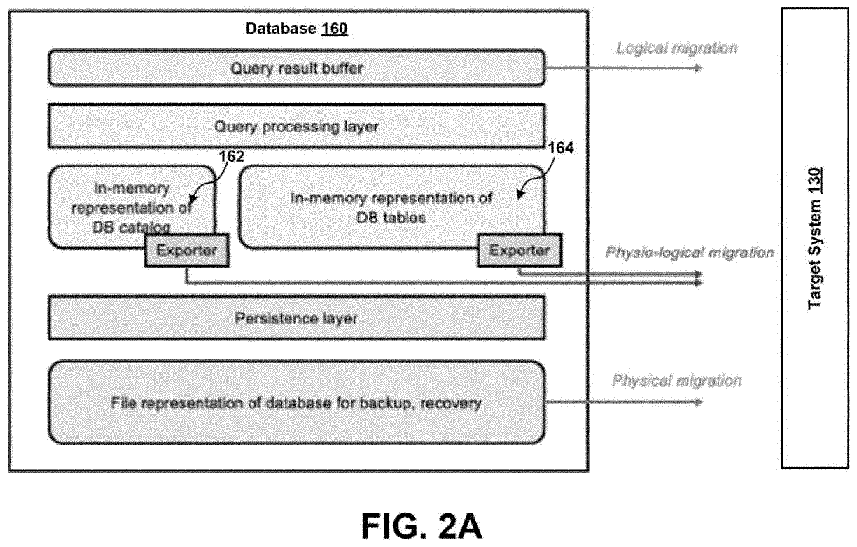

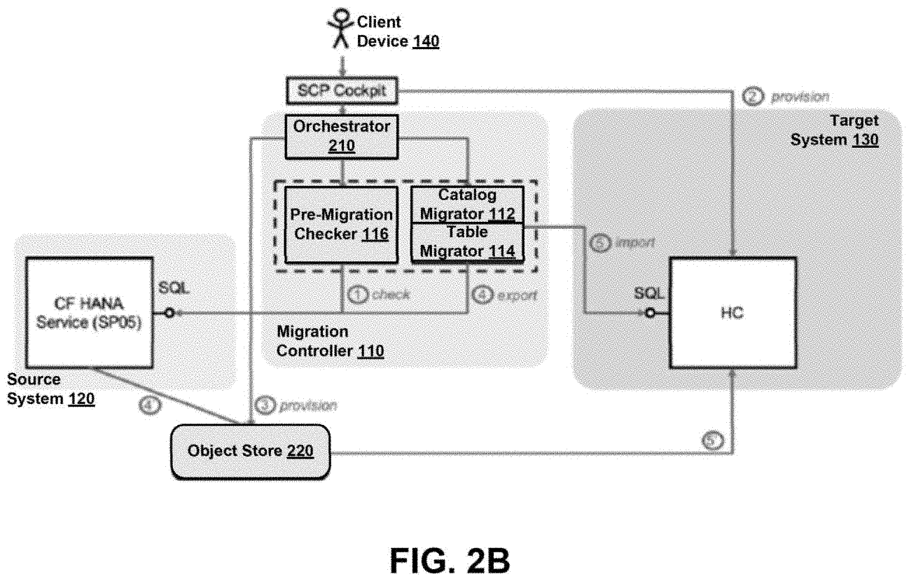

FIG. 2A depicts a schematic diagram illustrating an example of a physio-logical migration of the database 160, in accordance with some example embodiments. FIG. 2B depicts a schematic diagram illustrating an example of a process for a physio-logical migration of the database 160 from the source system 120 to the target system 130, in accordance with some example embodiments. Referring to FIGS. 1 and 2A-B, prior to initiating the physio-logical migration of the database 160 from the source system 120 to the target system 130, the pre-migration checker 116 may connect to the source system 120 (e.g., via the network 150) and verify the status of the source system 120. A user at the client device 140 may provision the target system 130 via, for example, a user interface 145 at the client device 140.

In some example embodiments, the target system 130 may be a cloud-based system located in a cloud space. Accordingly, the migration controller 110, for example, an orchestrator 210 at the migration controller 110, may provision a sufficient quantity of storage resources (e.g., file folders, buckets, and/or the like) at a cloud-based object store 220 for the data associated with the database 160 (e.g., the catalogs 162, the tables 164, and/or the like). The migration controller 110, for example, the catalog migrator 112 and the table migrator 114, may initiate an export operation from the source system 120 to the object store 220. Moreover, the migration controller 110, for example, the catalog migrator 112 and the table migrator 114, may initiate an import operation from the object store 220 to the target system 130.

In some example embodiments, the data associated with the database 160 (e.g., the catalogs 162, the tables 164, and/or the like) may be encrypted during the migration from the source system 120 to the target system 130. The physio-logical migration may be performed in real time by at least implementing real time replication. Moreover, the catalog migrator 112 and the table migrator 114 may be configured as micro services that are integrated as part of the migration controller 110. Alternatively, the catalog migrator 112 and the table migrator 114 may be configured as standalone tools that are invoked individually for independent operation.

In some example embodiments, instead of the table migrator 114, which exports the contents of the tables 164 in a binary representation, the catalog migrator 112 may be coupled with a table migrator configured to export the content of the tables 164 in a different representation (e.g., a comma-separated value (CSV) format and/or the like) and use Structured Query Language (SQL) queries to retrieve the contents of the tables 164 (e.g., via a Java Database Connectivity (JDBC) connection, an Open Database Connectivity (ODBC) connection, and/or the like). Alternatively and/or additionally, instead of the catalog migrator 112, which exports the contents of the catalogs 162 in a data interchange format (e.g., a JavaScript Object Notation (JSON) representation and/or the like), the table migrator 114 may be coupled with a catalog migrator configured to export the catalogs 162 of the database 160 in a different representation, for example, a comma-separated value (CSV) format, if the structure of the catalogs 162 is simple or if the catalogs 162 may be repopulated at the target system 130 (e.g., by re-executing the corresponding Data Definition Language (DDL) commands).

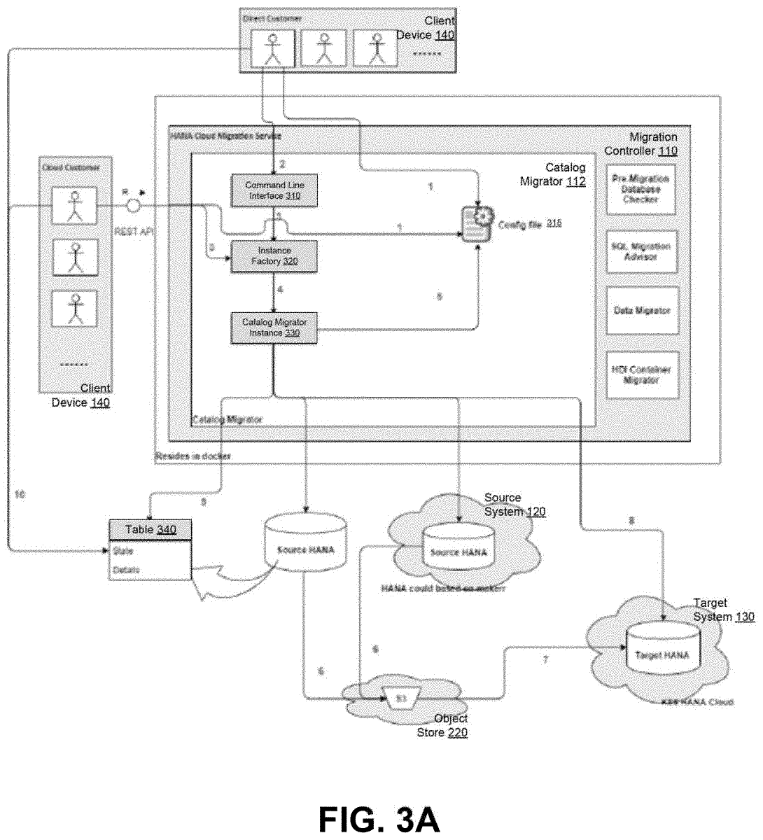

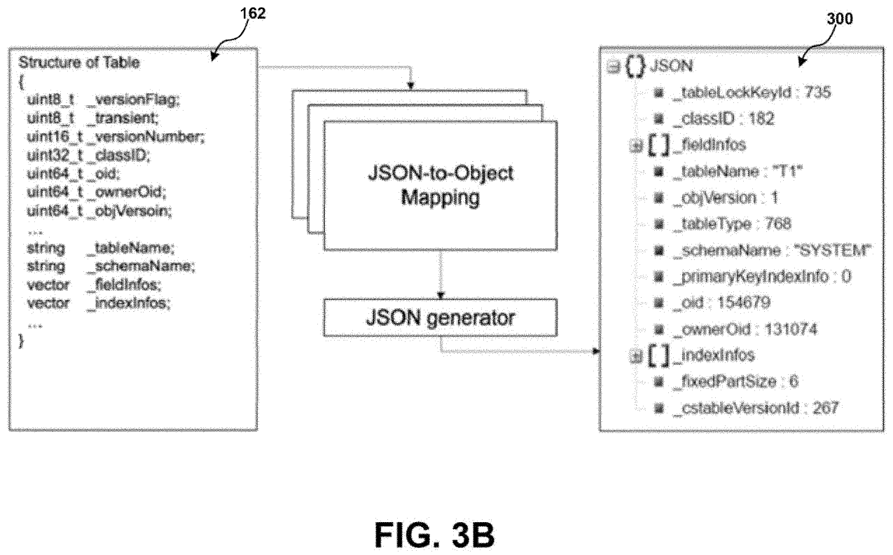

FIG. 3A depicts a block diagram illustrating an example of an architecture of the catalog migrator 112 implemented as a standalone tool, in accordance with some example embodiments. In some example embodiments, the catalog migrator 112 may be implemented as a script program (e.g., a Python script program), in which case the user at the client device 140 may interact with the catalog migrator 112 directly via a command line or through an application programming interface (API), such as a Restful API, provided by the user interface 145 at the client device 140. As noted, the catalog migrator 112 may be configured to export the catalogs 162 of the database 160 in a data interchange format, such as a JavaScript Object Notation (JSON) representation, that preserves the hierarchical structure present in the entities included in the catalogs 162. FIG. 3B depicts an example a portion of the catalogs 162 and a corresponding JavaScript Object Notation (JSON) representation 300 of the catalogs 162, in accordance with some example embodiments.

When the target system 130 is a cloud-based system, the physio-logical migration of the database 160 maybe performed by exporting, to the cloud-based object store 220, the catalogs 162 of the database 160 in a data interchange format (e.g., a JavaScript Object Notation (JSON) format and/or the like) before importing, from the cloud-based object store 220 to the target system 130, the catalogs 162 of the database 160 in the data interchange format. Table 1 below depicts an example of a sequence of commands to initiate the export of the catalogs 162 in the JavaScript Object Notation (JSON) format from the source system 120 to the cloud-based object store 220.

TABLE 1
create user User1 password ...;
grant CATALOG READ to User1;
grant EXPORT to User1;
grant EXECUTE on SYS.EXPORT_CATALOG_FOR_MIGRATION_DEV to User1;
connect User1 password ...;
call SYS.EXPORT_CATALOG_FOR_MIGRATION_DEV, (‘<path to S3 bucket>’, ‘’, ‘’);

Table 2 below depicts an example of a sequence of commands to initiate an import of the catalogs 162 in the JavaScript Object Notation (JSON) format from the cloud-based object store 220 to the target system 130.

TABLE 2
connect DBADMIN password ...;
grant EXECUTE on SYS.IMPORT_CATALOG_FOR_MIGRATION_DEV to SYSTEM with GRANT OPTION;
call SYS.IMPORT_CATALOG_FOR_MIGRATION_DEV, (‘<path to S3 buckets>’, ‘’, ‘’);

In some example embodiments, the user at the client device 140 may invoke the catalog migrator 112 individually as a standalone tool to migrate, for example, the catalogs 162 of the database 160 from the source system 120 to the target system 130. For example, a configuration file 315 may be generated at the client device 140 to include an instance information associated with the source system 120 and the target system 130 (e.g., hostname, port, user, password, and/or the like) as well as connection information associated with the cloud-based object store 220 (e.g., region, access key, identifier, secret access key, storage resource name, and/or the like). The source system 120 and the target system 130 may also be configured to access the cloud-based object store 220, for example, the storage resources (e.g., file folders, buckets, and/or the like) allocated for storing the catalogs 162. The migration of the catalogs 162 may be triggered by the user executing the catalog migrator 112, for example, by entering a corresponding command (e.g., $ catalogMigrator -c../config.yaml) in a command line at the client device 140.

Referring again to FIG. 3A, in response to the command executing the catalog migrator 112, a command line interface 310 obtain, from an instance factor 320, a catalog migrator instance 330 before executing a run method of the catalog migrator instance 330. In response to the command line interface 310 executing the run method of the catalog migrator instance 330, the catalog migrator instance 330 may read the configuration file 315 including the instance information associated with the source system 120 and the target system 130 (e.g., hostname, port, user, password, and/or the like) and the connection information associated with the cloud-based object store 220 (e.g., region, access key, identifier, secret access key, storage resource name, and/or the like).

The catalog migrator instance 330 may connect, based on the instance information included in the configuration file 315, to the source system 120 and call a procedure (e.g., SYS.EXPORT_CATALOG_FOR_MIGRATION_DEV) to export the catalogs 162 of the database 160 from the source system 120. Moreover, the catalog migrator instance 330 may connect, based on the instance information included in the configuration file 315, to the target system 130 and call a procedure (e.g., SYSIMPORT_CATALOG_FOR_MIGRATION_DEV) to import the catalogs 162 of the database 160 to the target system 130. Once connected to the target system 130, the catalog migrator instance 330 may also call a procedure (e.g., SYS.CHECK_CATALOG) to repair a topology of the catalogs 162 imported to the target system 130. During the migration of the catalogs 162, the catalog migrator 110 may update a table 340 at the source system 120 to include a status of the migration as well as one or more corresponding statistics. The user at the client device 140 may monitor the progress of the migration by at least querying the table 340 at the source system 120. Table 3 below depicts an example of structured query language (SQL) statement creating, at the source system 120, the table 340.

TABLE 3
SQL
CREATE ROW TABLE <CURRENT USER>.CATALOG_MIGRATOR_STATISTICS(SOLUTION NVARCHAR(30) NOT NULL,

RUNID BIGINT NOT NULL,
START_TIME TIMESTAMP NOT NULL,
END_TIME TIMESTAMP NULL,
STATE NVARCHAR(30) NOT NULL,
DETAILS NCLOB NULL);

Referring to Table 3, the table 340 may include a solution name (e.g., SOLUTION), a unique identifier for the run (e.g., RUNID), a start time of the run (e.g., START_TIME), an end time of the run (e.g., END_TIME), a state of the run (e.g., INITIAL, STARTED, EXPORTED, IMPORTED, SUCCESS, or ERROR), and one or more details of the run (e.g., a reason for the state of the run such as a reason for a failure state). An example of a result of querying the table 340 is shown below in Table 4.

TABLE 4
SQL Result
SELECT * FROM SYSTEM.CATALOG_MIGRATOR_STATISTICS

| | SOLUTION | RUNID | START_TIME | END_TIME | STATE | DETAILS |
|---|---|---|---|---|---|---|
| 1 | JsonExpImp | 1,594,095,639 | Jul. 6, 2020 | Jul. 6, 2020 | ERROR | Failed to execute CALL |
| | | | 9:20:41.339 PM | 9:21:24.259 PM | | SYS.IMPORT_CATALOG_FOR_MIGRATION_{—} |
| 2 | JsonExpImp | 1,594,096,192 | Jul. 6, 2020 | Jul. 6, 2020 | ERROR | Failed to execute CALL |
| | | | 9:29:53.08 PM | 9:30:15.861 PM | | SYS.IMPORT_CATALOG_FOR_MIGRATION_{—} |
| 3 | JsonExpImp | 1,594,096,310 | Jul. 6, 2020 | Jul. 6, 2020 | ERROR | Failed to execute CALL |
| | | | 9:31:51.127 PM | 9:32:11.024 PM | | SYS.IMPORT_CATALOG_FOR_MIGRATION_{—} |
| 4 | JsonExpImp | 1,594,096,839 | Jul. 6, 2020 | Jul. 6, 2020 | EXPORTED | |
| | | | 9:40:40.229 PM | 9:41:06.453 PM | | |
| 5 | JsonExpImp | 1,594,097,337 | Jul. 6, 2020 | Jul. 6, 2020 | ERROR | Failed to execute CALL |
| | | | 9:48:57.785 PM | 9:52:42.316 PM | | SYS.IMPORT_CATALOG_FOR_MIGRATION_{—} |
| 6 | JsonExpImp | 1,594,098,272 | Jul. 6, 2020 | Jul. 6, 2020 | ERROR | Failed to execute CALL |
| | | | 10:04:48.491 . . . | 10:04:48.491 . . . | | SYS.IMPORT_CATALOG_FOR_MIGRATION_{—} |

Instead of a standalone service, the catalog migrator 112 may also be implemented as one of multiple micro services included in the migration controller 110. When the catalog migrator 112 is implemented as a micro service, the catalog migrator 112 may be invoked by the user at the client device 140 providing, to the migration controller 110, configuration information for migrating the database 160 from the source system 120 to the target system 130. The migration controller 110 may generate, based at least on the configuration information received from the client device 140, a configuration memory object. The migration controller 110 may obtain, from the instance factory 320, the catalog migrator instance 330 before transferring the configuration memory object to the catalog migrator instance 330 and executing the run method of the catalog migrator instance 330.

In response to the migration controller 110 executing the run method of the catalog migrator instance 330, the catalog migrator instance 330 may read the configuration file 315 including the instance information associated with the source system 120 and the target system 130 and the connection information associated with the cloud-based object store 220. The catalog migrator instance 330 may connect, based on the instance information included in the configuration file 315, to the source system 120 and export the catalogs 162 of the database 160, for example, by calling a corresponding procedure. Furthermore, the catalog migrator instance 330 may connect, based on the instance information included in the configuration file 315, to the target system 130 and call a procedure to import the catalogs 162 of the database 160 to the target system 130 as well as a procedure to repair a topology of the catalogs 162 imported to the target system 130. During the migration of the catalogs 162, the catalog migrator 110 may, as noted, update the table 340 at the source system 120 to include a status of the migration as well as one or more corresponding statistics. Doing so may enable the migration controller 110 to monitor the progress of the migration by at least querying the table 340 at the source system 120.

The catalogs 162 of the database 160 may include a variety of entities including, for example, users, privileges, credentials, and/or the like. As noted, a physio-logical migration of the database 160 may include exporting the catalogs 162 in a data interchange format, such as a JavaScript Object Notation (JSON) format, that preserves the hierarchical dependencies present amongst the entities of the catalogs 162 including, for example, one or more users, privileges, credentials, and/or the like. Moreover, the physio-logical migration of the database 160 may be performed selectively to exclude one or more portions of the database 160 from being migrated to the target system 130. Accordingly, in some example embodiments, migrating the catalogs 162 of the database 160 may include migrating the users defined at the source system 120 while excluding types of users not permitted at the target system 130. For example, while administrative users defined at the source system 120 may be migrated to the target system 130, system users may be permitted at the target system 130, in which case system users are excluded from the physio-logical migration of the database 160. Database objects owned by system users may therefore also be excluded from the migration. However, unless a privilege is discontinued, privileges granted by system users at the source system 120 may remain a part of the migration.

In some example embodiments, migrating the catalogs 162 of the database 160 may also include migrating the privileges defined at the source system 120 although the catalog migrator 112 may be configured to revoke privileges not permitted at the target system 130. For example, the target system 130 may not support user administrator privileges, in which case the catalog migrator 112 may revoke user administrator privileges as part of migrating the catalogs 162 to the target system 130. Alternatively and/or additionally, the target system 130 may require each user to be included in a user group. As such, as part of migrating the catalogs 162 to the target system 130, the catalog migrator 112 may assign, to a default user group, one or more users who are not part of a user group at the source system 120.

In some example embodiments, the catalog migrator 112 may also selectively exclude, from being migrated to the target system 130, one or more users and/or roles specified by the user at the client device 140. For example, the user at the client device 140 may specify, as part of the configuration file 315 generated at the client device 140, one or more users and/or roles to exclude from the migration. The catalog migrator 112 may therefore exclude, from being migrated to the target system 130, the users and/or roles specified in the configuration file 315.

To further illustrate, Table 5 below depicts an example of the configuration file 315 specifying, for exclusion from the migration to the target system 130, the user DEMOUSER, the user SAPDB, and the role DBA COCKPIT. As shown in Table 4, the users DEMOUSER and SAPDB may be excluded from the migration to the target system 130 by setting blackUserList to include the users DEMOUSER and SAPDB. Moreover, the role DBA COCKPIT may be excluded from the migration to the target system by setting blackRoleList to include the role DBA COCKPIT.

TABLE 5
# Catalog Migration task plan.
plan:

| | |
|---|---|
| name: Catalog migration | # Configuration name, user can customize. |
| source: | # Source HANA informations will be specified as |

| | |
|---|---|
| host: xxxxxxxxxxx.sjc.sap.corp | # Source HANA host name. |
| port: 30015 | # Source HANA port number. |
| user: USER1 | # Source HANA user name. |
| password: PASSWORD | # Source HANA user password. |
| blackUserList: SAPDB%,DEMOUSER | # Not migrated user List, split by comma. E.g., |

| | |
|---|---|
| # | Support percent sign (%) and underscore (_{—} |
| # | %-matches one or more characters. |
| # | _-matches one character. |

| | |
|---|---|
| blackRoleList: DBA_COCKPIT | # Not migrated role List, split by comma. E.g., |

| | |
|---|---|
| # | Support percent sign (%) and underscore (_{—} |
| # | %-matches one or more characters. |
| # | _-matches one character. |

| | |
|---|---|
| target: | # Target HANA informations will be specified as |

| | |
|---|---|
| host: xxxxxxxxxxx.sjc.sap.corp | # Target HANA host name. |
| port: 30015 | # Target HANA port number. |
| user: DBADMIN | # Target HANA user name. |
| password: PASSWORD | # Target HANA user password. |

# Data Migration task execution configuration.
execution:

| | |
|---|---|
| ExptImpt_config: | # Migration using Export and Import will be conf |

| | |
|---|---|
| s3_config: | # S3 configuration will be specified as below. |

| region: eu-central-1 | # S3 region. |
|---|---|
| access_key_id: xxxxxxxxxxxxxx | # S3 access key id. |
| secret_access_key: xxxxxxxxxxxxxxx # S3 secret access key. | |
| bucket_name: xxxxxxxxxxxxx | # S3 bucket name. |

| | |
|---|---|
| folder: xxxxxxxx | # S3 folder name under the bucket. catalog_shared_disk_path: # If the path is specified, it will replace s3 |

to save the

In some example embodiments, credentials stored at the source system 120 may be encrypted using a root key stored outside of the source system 120. As such, due to security concerns, credentials, including remote source credentials, may be excluded from the migration of the catalogs 162 from the source system 120 to the target system 130. Alternatively, credentials may be migrated from the source system 120 to the target system 130 by migrating decrypted credentials or by migrating the encrypted credentials as well as the root key. The migrating of decrypted credentials may be accomplished over a secure communication channel, such as a direct transport layer security (TLS) connection, between the source system 120 and the target system 130. If the migration of the database 160 is performed with the cloud-based object store 220 as an intermediate data store, access to the cloud-based object store 220 may be limited to the migration controller 110.

Referring again to FIGS. 1 and 2A-B, in addition to the catalog migrator 112 exporting the catalogs 162 of the database 160 in the data interchange format (e.g., a JavaScript Object Notation (JSON) representation and/or the like), the physio-logical migration of the database 160 may also include the table migrator 114 migrating the contents of the tables 164 of the database 160 in a binary representation that is compatible with the target system. In some example embodiments, the table migrator 114 may export the contents of the tables 164 in a data buffer, which may be a data structure configured provide an efficient serialization and deserialization of tabular data including, for example, multiple columns having database types but a same quantity of cells. To migrate the tables 164 of the database 160, the corresponding data buffers may be sent over the network 150 and/or stored at the cloud-based object store 220 (e.g., in one or more buckets, file folders, and/or the like).

The data buffer may be a flat data structure that minimizes duplicate copies of the same data. The in-memory representation of a data buffer may include a collection of contiguous memory areas corresponding to a metadata portion, a fixed size portion, and a page chain portion. The metadata portion of a data buffer may hold information, such as size, column types, and offsets, that enables the target system 130 to parse the data buffer and retrieve the contents of the tables 164 to reconstruct the tables 164 at the target system 130. The fixed size portion of a data buffer may include the fixed-size data for each cell. For example, for fixed-size datatypes such as integers, the fixed size portion of a data buffer may contain the value. Alternatively, for variable-size datatypes such as strings, the fixed size portion of a data buffer may include a reference (e.g., a pointer and/or the like) to the value. The page chain portion of a data buffer may hold content having a variable size.

In some example embodiments, a data buffer may be serialized by concatenating the memory areas containing the metadata portion, the fixed size portion, and the page chain portion of the data buffer. The serialization of a data buffer may therefore be performed efficiently, for example, by a form of gather I/O. Because a serialized data buffer may be single contiguous memory block, deserialization of the data buffer may be accomplished without decoding or copying.

In some example embodiments, individual data buffers may be blocked to enable parallel operations. For example, a data buffer may be blocked, with each block capable of being written independently, for example, to the cloud-based object store 220 and/or the target system 130. A single block may be a self-contained data buffer having a metadata portion, a fixed size portion, and a page chain portion. In addition, the block may include a master metadata portion storing information about the layout of the block.

In some example embodiments, data buffers may be compressed, for example, using run-length encoding of identical values within a column. The compression of the data buffers may further including storing null values as a single bit. For example, each cell may include two bits with a first bit indicating whether the cell holds a null value and a second bit indicating whether the value of the cell is the same as a previous cell in the same column.

In some example embodiments, the migrations of the contents of the tables 164 of the database 160 may be accomplished by exporting the corresponding data buffers from the source system 120 and importing the data buffers into the target system 130. A sequence of data buffers may be used to represent data from a coherent block of rows belonging to a single one of the tables 164 from the database 160. A data buffer chunk or chunk may refer to individual elements in the sequence of data buffers, with the quantity of rows included in each chunk being variable from one chunk to the next. Each chunk may include an identifier indicating its position in a corresponding sequence of data buffers. These identifier may be used to detect gaps (e.g., missing chunks) in a sequence of data buffers. Instead of the contents of the tables 164, it should be appreciated that the first chunk in a sequence of data buffers may include metadata identifying the column names, the internal column identifiers, and the order of columns present in the sequence of data buffers. When the sequence of data buffers is imported into the target system 130, for example, during the migration of the tables 164, the target system 130 may process the first chunk of the sequence of data buffers differently whereas the remaining chunks may be forwarded indirectly for insertion at the target system 130 (e.g., via one or more data modification language (DML) statements).

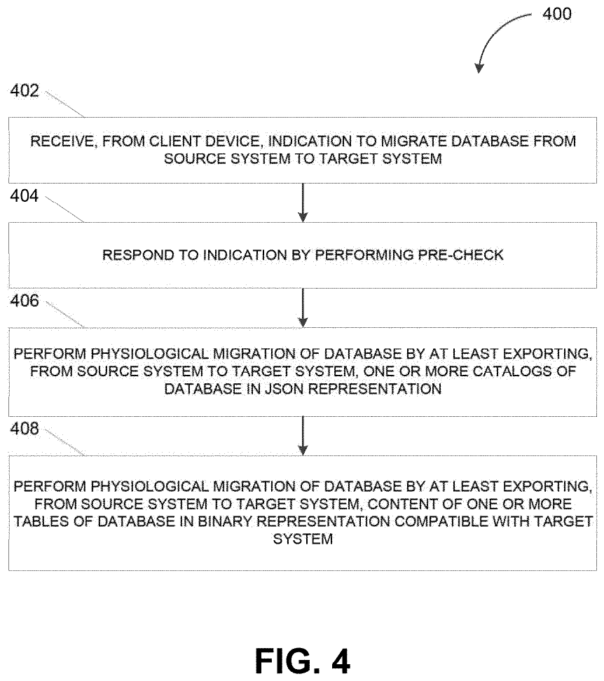

FIG. 4 depicts a flowchart illustrating a process 400 for migrating a database, in accordance with some example embodiments. Referring to FIGS. 1, 2A-B, 3A-B, and 4, the process 400 may be performed by the migration controller 110 to achieve, for example, a physio-logical migration of the database 160 from the source system 120 to the target system 130.

At 402, the migration controller 110 may receive an indication to migrate a database from a source system to a target system. In some example embodiments, in order to trigger a physio-logical migration of the database 160 from the source system 120 to the target system 130, the user at the client device 140 may interact with the migration controller 110 through a command line or through an application programming interface (API), such as a Restful API, provided by the user interface 145 at the client device 140. The migration controller 110 may be a micro service based application that includes the catalog migrator 112 and the table migrator 114 as individual micro services. As such, the user at the client device 140 sending, to the migration controller 110, configuration information may trigger the catalog migrator 112 as well as the table migrator 114. Alternatively and/or additionally, the catalog migrator 112 and the table migrator 114 included in the migration controller 110 may be implemented as standalone tools that the user at the client device 140 may invoke individually.

At 404, the migration controller 110 may respond to the command by at least performing a pre-check. In some example embodiments, the migration controller 110 may include the pre-migration checker 116 configured to verify a status of the source system 120 and/or the target system 130 prior to initiating the physio-logical migration of the database 160 from the source system 120 to the target system 130.

At 406 the migration controller 110 may perform a physio-logical migration of the database, by at least exporting, from the source system to the target system, one or more catalogs of the database in a data interchange format that preserves an hierarchical dependency amongst a plurality of entities include in the one or more catalogs. In some example embodiments, the migration controller 110, for example, the catalog migrator instance 330 generated by the instance factory 320 of the catalog migrator 162, may be configured to export the catalogs 162 of the database 160 in a JavaScript Object Notation (JSON) representation in order to preserve the hierarchical dependencies present amongst the entities included in the catalogs 162. For example, the catalog migrator 162 may connect to the source system 120 and call a procedure (e.g., SYS.EXPORT_CATALOG_FOR_MIGRATION_DEV) to export the catalogs 162 of the database 160 from the source system 120. Moreover, the catalog migrator 162 may connect to the target system 130 and call a procedure (e.g., SYSIMPORT_CATALOG_FOR_MIGRATION_DEV) to import the catalogs 162 of the database 160 to the target system 130. Once connected to the target system 130, the catalog migrator 112 may also call a procedure (e.g., SYS.CHECK_CATALOG) to repair a topology of the catalogs 162 imported to the target system 130.

When the target system 130 is a cloud-based system, the migration controller 110, for example, the catalog migrator 112, may export, to the cloud-based object store 220, the catalogs 162 of the database 160 in a JavaScript Object Notation (JSON) format before importing, from the cloud-based object store 220 to the target system 130, the catalogs 162 of the database 160 in the JavaScript Object Notation (JSON) format. During the migration of the catalogs 162, the catalog migrator 110 may update the table 340 at the source system 120 to include a status of the migration as well as one or more corresponding statistics. Doing so may enable the user at the client device 140 to monitor the progress of the migration by at least querying the table 340 at the source system 120.

At 408, the migration controller 110 may perform a physio-logical migration of the database by at least exporting, from the source system to the target system, a content of one or more tables of the database in a binary representation compatible with the target system. In some example embodiments, the migration controller 110, for example, the table migrator 114, may be configured to export the contents of the tables 164 included in the database 160 in a binary representation. For example, to export the contents of the tables 164 from the source system 120 to the target system 130, the table migrator 114 may generate one or more corresponding data buffers, which may be data structures configured to provide an efficient serialization and deserialization of tabular data.

The in-memory representation of a data buffer may include a collection of contiguous memory areas corresponding to a metadata portion, a fixed size portion, and a page chain portion. The metadata portion of a data buffer may hold information, such as size, column types, and offsets, that enables the target system 130 to parse the data buffer and retrieve the contents of the tables 164 to reconstruct the tables 164 at the target system 130. The fixed size portion of a data buffer may include the fixed-size data for each cell such as values of fixed-size datatypes or references (e.g., a pointer and/or the like) to the values of variable size datatypes. The page chain portion of a data buffer may hold content having a variable size.

To enable parallel operations, individual data buffers may be blocked, with each block being a self-contained data buffer having a metadata portion, a fixed size portion, a page chain portion, and an additional master metadata portion storing information on block layout. Moreover, the data buffers including the contents of the tables 164 may be compressed, for example, using run-length encoding of identical values within a column. In some example embodiments, the migrations of the contents of the tables 164 of the database 160 may be accomplished by exporting the corresponding data buffers from the source system 120 and importing the data buffers into the target system 130. A sequence of data buffers may be used to represent data from a coherent block of rows belonging to a single one of the tables 164 from the database 160, with chunks being the individual elements in the sequence of data buffers. Each chunk of from a sequence of data buffers may include an identifier that enables the detection of gaps (e.g., missing chunks) by at least indicating its position in the sequence of data buffers. Instead of the contents of the tables 164, the first chunk in a sequence of data buffers may include metadata identifying the column names, the internal column identifiers, and the order of columns present in the sequence of data buffers. As such, when the sequence of data buffers is imported into the target system 130, the target system 130 may process the first chunk of the sequence of data buffers differently than the remaining chunks in the sequence of data buffers, which may be forwarded indirectly for insertion at the target system 130 (e.g., via one or more data modification language (DML) statements).

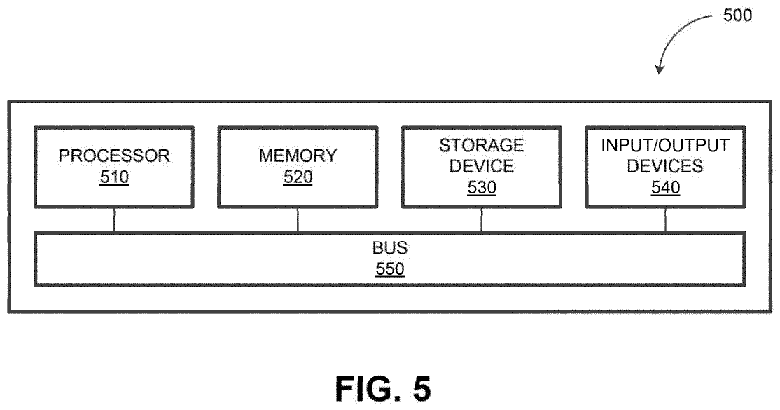

FIG. 5 depicts a block diagram illustrating a computing system 500 consistent with implementations of the current subject matter. Referring to FIGS. 1 and 5, the computing system 500 can be used to implement the migration controller 110 and/or any components therein.

As shown in FIG. 5, the computing system 500 can include a processor 510, a memory 520, a storage device 530, and input/output devices 540. The processor 510, the memory 520, the storage device 530, and the input/output devices 540 can be interconnected via a system bus 550. The processor 510 is capable of processing instructions for execution within the computing system 500. Such executed instructions can implement one or more components of, for example, the migration controller 110 and/or the like. In some example embodiments, the processor 510 can be a single-threaded processor. Alternately, the processor 510 can be a multi-threaded processor. The processor 510 is capable of processing instructions stored in the memory 520 and/or on the storage device 530 to display graphical information for a user interface provided via the input/output device 540.

The memory 520 is a computer readable medium such as volatile or non-volatile that stores information within the computing system 500. The memory 520 can store data structures representing configuration object databases, for example. The storage device 530 is capable of providing persistent storage for the computing system 500. The storage device 530 can be a floppy disk device, a hard disk device, an optical disk device, a tape device, a solid state drive, and/or other suitable persistent storage means. The input/output device 540 provides input/output operations for the computing system 500. In some example embodiments, the input/output device 540 includes a keyboard and/or pointing device. In various implementations, the input/output device 540 includes a display unit for displaying graphical user interfaces.

According to some example embodiments, the input/output device 540 can provide input/output operations for a network device. For example, the input/output device 540 can include Ethernet ports or other networking ports to communicate with one or more wired and/or wireless networks (e.g., a local area network (LAN), a wide area network (WAN), the Internet).

In some example embodiments, the computing system 500 can be used to execute various interactive computer software applications that can be used for organization, analysis and/or storage of data in various formats. Alternatively, the computing system 500 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing items and/or functionalities. Upon activation within the applications, the functionalities can be used to generate the user interface provided via the input/output device 540. The user interface can be generated and presented to a user by the computing system 500 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program item, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A system, comprising:
at least one data processor; and
at least one memory storing instructions which, when executed by the at least one data processor, result in operations comprising:
receiving, from a client device, an indication to migrate a database from a source system to a target system; and
in response to the indication, performing a physio-logical migration of the database by at least
exporting, from the source system, one or more catalogs of the database in a data interchange format, the one or more catalogs including a plurality of entities, and the data interchange format preserving a hierarchical dependency amongst the plurality of entities, and
exporting, from the source system, a content of one or more tables of the database in a binary format.

2. The system of claim 1, further comprising:
excluding, based at least on the indication from the client device, a portion of the one or more catalogs and/or the one or more tables from being migrated to the target system.

3. The system of claim 1, wherein the binary format comprises a data buffer including a metadata portion, a fixed size portion, and a page chain portion, wherein the metadata portion includes information that enables the target system to parse the data buffer, wherein the fixed size portion includes one or more fixed-size values, and wherein the page chain portion includes one or more variable-size values.

4. The system of claim 1, wherein the content of the one or more tables of the database is exported in one or more sequences of data buffers, and wherein each of the one or more sequences of data buffers stores data from one row of a table in the database.

5. The system of claim 4, wherein each of the one or more sequences of data buffers includes a plurality of chunks, wherein each of the plurality of chunks is associated with an identifier to enable a detection of one or more missing chunks, and wherein a first chunk in the plurality of chunks includes metadata identifying a name, an internal identifier, and/or an order of one or more columns included in a corresponding row.

6. The system of claim 1, wherein the data interchange format comprises a JavaScript Object Notation (JSON) format.

7. The system of claim 1, wherein the exporting of the one or more catalogs of the database includes exporting a first user and/or a first privilege defined at the source system, and wherein the exporting of the one or more catalogs of the database excludes a second user and/or a second privilege not supported at the target system.

8. The system of claim 1, wherein the exporting of the one or more catalogs of the database includes exporting one or more credentials.

9. The system of claim 8, wherein the exporting of the one or more credentials includes decrypting, based at least on a root key, the one or more credentials prior to exporting the one or more credentials.

10. The system of claim 8, wherein the exporting of the one or more credentials includes exporting the one or more credentials encrypted using a root key and the root key for decrypting the one or more credentials.

11. The system of claim 1, wherein the physio-logical migration of the database further includes importing, to the target system, the one or more catalogs of the database in the data interchange format and the content of the one or more tables of the database in the binary format.

12. The system of claim 11, wherein the one or more catalogs and/or the content of the one or more tables are exported from the source system to a cloud-based object store before being imported to the target system from the cloud-based object store.

13. The system of claim 1, wherein the source system comprises a legacy system, and wherein the target system comprises a cloud-based system.

14. The system of claim 1, wherein the source system and the target system comprise in-memory, column-oriented, relational database systems.

15. A computer-implemented method, comprising:
receiving, from a client device, an indication to migrate a database from a source system to a target system; and
in response to the indication, performing a physio-logical migration of the database by at least
exporting, from the source system, one or more catalogs of the database in a data interchange format, the one or more catalogs including a plurality of entities, and the data interchange format preserving a hierarchical dependency amongst the plurality of entities, and
exporting, from the source system, a content of one or more tables of the database in a binary format.

16. The method of claim 15, further comprising:
excluding, based at least on the indication from the client device, a portion of the one or more catalogs and/or the one or more tables from being migrated to the target system.

17. The method of claim 15, wherein the binary format comprises a data buffer including a metadata portion, a fixed size portion, and a page chain portion, wherein the metadata portion includes information that enables the target system to parse the data buffer, wherein the fixed size portion includes one or more fixed-size values, and wherein the page chain portion includes one or more variable-size values.

18. The method of claim 15, wherein the data interchange format comprises a JavaScript Object Notation (JSON) format.

19. The system of claim 1, wherein the physio-logical migration of the database further includes importing, to the target system, the one or more catalogs of the database in the data interchange format and the content of the one or more tables of the database in the binary format, and wherein the one or more catalogs and/or the content of the one or more tables are exported from the source system to a cloud-based object store before being imported to the target system from the cloud-based object store.

20. A non-transitory computer readable medium storing instructions, which when executed by at least one data processor, result in operations comprising:
receiving, from a client device, an indication to migrate a database from a source system to a target system; and
in response to the indication, performing a physio-logical migration of the database by at least
exporting, from the source system, one or more catalogs of the database in a data interchange format, the one or more catalogs including a plurality of entities, and the data interchange format preserving a hierarchical dependency amongst the plurality of entities, and
exporting, from the source system, a content of one or more tables of the database in a binary format.
